(19) United States
(12) Patent Application Publication
(10) Pub. No.: US 2026/0139807 A1
(43) Pub. Date: May 21, 2026

(54) HIGH AND LOW BEAM INTEGRATED LIGHTING APPARATUS AND VEHICLE LAMP

(71) Applicant: HASCO VISION TECHNOLOGY CO., LTD., Shanghai (CN)

(72) Inventors: Shikun DONG, Shanghai (CN); Jie ZHANG, Shanghai (CN); Jiayuan CHEN, Shanghai (CN); Cong LI, Shanghai (CN); Fang LIU, Shanghai (CN); He ZHU, Shanghai (CN); Wenhui SANG, Shanghai (CN); Yuling ZHANG, Shanghai (CN)

(21) Appl. No.: 19/119,695

(22) PCT Filed: Sep. 8, 2023
(86) PCT No.: PCT/CN2023/117699

§ 371 Date: Apr. 9, 2025

(30) Foreign Application Priority Data
Dec. 5, 2022 (CN) 202211551897.8

(51) Int. Cl. F21S 41/265; F21S 41/26; F21S 41/275; F21S 41/32; F21S 41/36; F21W 102/155

(52) U.S. Cl. CPC F21S 41/265; F21S 41/26; F21S 41/275; F21S 41/321; F21S 41/36; F21W 2102/155

(57) ABSTRACT

Provided are high and low beam integrated lighting apparatus and vehicle lamp. Apparatus includes two light-emitting modules arranged in vertical direction. Each light-emitting module includes multiple light sources and optical units arranged in transverse direction. Each optical unit includes reflection part and lens unit located on light-emitting side of reflection part. Light sources are arranged corresponding to reflection parts. Each reflection part is provided with reflection face. Focuses of lens units are provided on reflection faces or near reflection faces. Light rays emitted by light sources are reflected by reflection faces and then are emitted by lens units to form light form units. Multiple light form units are combined to form light-emitting light forms of light-emitting modules. Two light-emitting modules are respectively low-beam module and high-beam module. Light-emitting faces of two light-emitting modules are connected to form smooth curved face.

### CROSS-REFERENCE TO RELATED APPLICATIONS

This is a U.S. 371 National Phase Application claiming priority to Application Serial No. PCT/CN 2023/117699 filed Sep. 8, 2023 and entitled “HIGH AND LOW BEAM INTEGRATED LIGHTING APPARATUS AND VEHICLE LAMP”, which claims priority to Chinese patent application no. 2022115518978 filed with the Chinese Patent Office on Dec. 5, 2022, and entitled “HIGH AND LOW BEAM INTEGRATED LIGHTING APPARATUS AND VEHICLE LAMP”, the contents of which are all incorporated herein by reference in their entirety.

### TECHNICAL FIELD

The present disclosure relates to the technical field of vehicle lamps, and specifically relates to a high and low beam integrated lighting apparatus and a vehicle lamp.

### BACKGROUND ART

With the development of the social economy, the automobile industry has also developed accordingly. With the continuous advancement of automotive lighting technology, more requirements have been proposed for the functions of vehicle lamps. In the lighting apparatus that realizes the lighting function of vehicle lamps, a dual-beam module integrating high and low beams is usually provided to achieve high-beam light patterns and low-beam light patterns, thereby obtaining a better lighting effect.

Existing dual-beam modules all share a single large lens (light-emitting element) for both high and low beams. However, in order to meet the requirements for light patterns, luminous efficiency, and other, modifications to the shared lens are required. In actual design, this often results in a chain reaction. For example, to meet the requirements of the low beam, when modifying the shared lens, the high-beam elements must also be adjusted accordingly to accommodate changes in the shared lens, which often leads to a prolonged development cycle. Furthermore, when performing optical design on a single large lens, it is difficult to simultaneously meet various requirements for multiple lighting functions.

### SUMMARY

The objective of the present disclosure is to address the deficiencies in the prior art and provide a high and low beam integrated lighting apparatus and a vehicle lamp to solve the problem that, when multiple modules share a single large lens, it is difficult to simultaneously meet the requirements of multiple modules.

In order to achieve the above objective, the technical solution adopted in the embodiments of the present disclosure is as follows.

In one aspect of the embodiments of the present disclosure, a high and low beam integrated lighting apparatus is provided, which includes two light-emitting modules that are arranged in the vertical direction. The light-emitting module includes multiple light sources and multiple optical units, wherein the multiple optical units are arranged in the transverse direction. The optical unit includes a reflection part and a lens unit located on a light-emitting side of the reflection part. The light sources are arranged to correspond to the reflection parts. The reflection part is provided with a reflection surface. Focuses of the lens units are provided on the reflection surfaces or near the reflection surfaces. Light rays emitted by the light sources are reflected by the reflection surfaces and then are emitted by means of the lens units, so as to form light pattern units. The multiple light pattern units are combined to form light-emitting patterns of the light-emitting modules.

One of the two light-emitting modules is a low-beam light-emitting module capable of forming a low-beam light pattern, and the other is a high-beam light-emitting module capable of forming a high-beam light pattern. Light-emitting surfaces of the two light-emitting modules are connected to form a smooth curved face.

Optionally, the lens unit includes one lens, and both a cross-section and a longitudinal section of a light incident surface of the lens are curved; or, one of the cross-section and the longitudinal section of the light incident surface of the lens is curved, and the other is a straight line.

Optionally, the lens unit includes an inner lens and an outer lens sequentially arranged on the light-emitting side of the reflection part. Adjacent inner lenses are spliced to form a module inner lens, and adjacent outer lenses are spliced to form a module outer lens.

Optionally, a light incident surface of the inner lens is configured to collimate light rays emitted from the reflection part along a first direction, and a light-emitting surface of the outer lens is configured to collimate light rays emitted from the reflection part along a second direction, wherein the first direction and the second direction are perpendicular.

Optionally, a curvature of the cross-section of the light incident surface of the inner lens located at a side portion of the module inner lens is greater than a curvature of the cross-section of the light incident surface of the inner lens located at a middle portion of the module inner lens.

Optionally, the reflection surface is any one of a parabolic surface, a quasi-parabolic surface, an ellipsoidal surface, and a quasi-ellipsoidal surface, and the reflection surface is capable of reflecting light rays emitted from the light sources substantially parallel to the lens unit.

Optionally, the lens unit of one of the low-beam light-emitting module and the high-beam light-emitting module includes one lens, and the lens unit of the other includes an inner lens and an outer lens sequentially arranged on the light-emitting side of the reflection part.

Optionally, the lens unit of the low-beam light-emitting module includes a low-beam inner lens and a low-beam outer lens sequentially arranged on the light-emitting side of the reflection part; the lens unit of the high-beam light-emitting module includes a high-beam inner lens and a high-beam outer lens sequentially arranged on the light-emitting side of the reflection part; adjacent low-beam inner lenses are spliced to form a low-beam module inner lens, and adjacent low-beam outer lenses are spliced to form a low-beam module outer lens. Adjacent high-beam inner lenses are spliced to form a high-beam module inner lens, and adjacent high-beam outer lenses are spliced to form a high-beam module outer lens.

Optionally, the low-beam module inner lens and the high-beam module inner lens are arranged in a front-rear direction; or, the low-beam module inner lens and the high-beam module inner lens are arranged in the vertical direction and integrally formed.

Another aspect of the embodiments of the present disclosure provides a vehicle lamp, which includes any one of the aforementioned high and low beam integrated lighting apparatuses.

The beneficial effects of the present disclosure include the following.

The present disclosure provides a high and low beam integrated lighting apparatus and a vehicle lamp, in which the low-beam light-emitting module and the high-beam light-emitting module are provided with optical units to achieve modularization. Therefore, during the design process, the optical units of the low-beam light-emitting module and the high-beam light-emitting module only need to consider the light-emitting requirements of their respective modules. This ensures that each light-emitting module remains relatively independent, allowing for more flexible modulation of individual light patterns without mutual interference. It eliminates the need to design a shared lens that must simultaneously meet the requirements of both the low-beam light-emitting module and the high-beam light-emitting module. Therefore, when adjustments are made to the low-beam light-emitting module or high-beam light-emitting module, it avoids affecting other light-emitting modules, which is conducive to shortening the research and development cycle.

### BRIEF DESCRIPTION OF DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in the art can also obtain other related drawings based on these drawings without inventive effort.

FIG. 1 is a schematic structural diagram of one example of a light-emitting module provided in the embodiments of the present disclosure;

FIG. 2 is a schematic structural diagram of another example of a light-emitting module provided in the embodiments of the present disclosure;

FIG. 3 is a schematic structural diagram of yet another example of a light-emitting module provided in the embodiments of the present disclosure;

FIG. 4 is a schematic structural diagram of a low-beam lighting apparatus provided in the embodiments of the present disclosure;

FIG. 5 is a schematic diagram of a primary low-beam light pattern provided in the embodiments of the present disclosure;

FIG. 6 is a schematic diagram of an auxiliary low-beam light pattern provided in the embodiments of the present disclosure;

FIG. 7 is a schematic structural diagram of one example of a high and low beam integrated lighting apparatus provided in the embodiments of the present disclosure;

FIG. 8 is a schematic structural diagram of another example of a high and low beam integrated lighting apparatus provided in the embodiments of the present disclosure;

FIG. 9 is a schematic structural diagram of yet another example of a high and low beam integrated lighting apparatus provided in the embodiments of the present disclosure;

FIG. 10 is a side view of one example of a high and low beam integrated lighting apparatus provided in the embodiments of the present disclosure;

FIG. 11 is a side view of another example of a high and low beam integrated lighting apparatus provided in the embodiments of the present disclosure;

FIG. 12 is a top view of a low-beam light-emitting module provided in the embodiments of the present disclosure;

FIG. 13 is a schematic diagram of an optical path of a low-beam light-emitting module provided in the embodiments of the present disclosure;

FIG. 14 is a schematic diagram of an intermediate light pattern formed by a third unit and a fourth unit of a low-beam light-emitting module provided in the embodiments of the present disclosure;

FIG. 15 is a schematic diagram of a right-half light pattern formed by a first unit of a low-beam light-emitting module provided in the embodiments of the present disclosure;

FIG. 16 is a schematic diagram of a left-half light pattern formed by a second unit of a low-beam light-emitting module provided in the embodiments of the present disclosure;

FIG. 17 is a schematic diagram of a light pattern formed by a low-beam light-emitting module provided in the embodiments of the present disclosure;

FIG. 18 is a schematic structural diagram of one example in which light-emitting surfaces of outer lenses of adjacent light-emitting modules are connected, provided in the embodiments of the present disclosure;

FIG. 19 is a schematic structural diagram of another example in which the light-emitting surfaces of outer lenses of adjacent light-emitting modules are connected, provided in the embodiments of the present disclosure;

FIG. 20 is a schematic structural diagram of yet another example in which the light-emitting surfaces of outer lenses of adjacent light-emitting modules are connected, provided in the embodiments of the present disclosure; and

FIG. 21 is an exploded view of a high and low beam integrated lighting apparatus provided in the embodiments of the present disclosure.

Reference numerals: 100—light-emitting module; 111—first unit; 112—second unit; 113—third unit; 114—fourth unit; 101—light source; 110—optical unit; 120—reflection part; 121—cut-off line structure; 130—lens; 141—module lens; 142—module inner lens; 143—module outer lens; 1431—surface shape formed by connecting the light-emitting surfaces of outer lenses of adjacent light-emitting modules; 150—inner lens; 160—outer lens; 181—low-beam inner lens; 182—low-beam outer lens; 191—high-beam inner lens; 192—high-beam outer lens; 210—auxiliary low-beam module; 220—primary low-beam module; 310—low-beam light-emitting module; 320—high-beam light-emitting module; 330—heat sink; 410—lens bracket; 420—inner lens assembly; 430—high-beam circuit board; 440—low-beam circuit board; 450—reflecting assembly.

### DETAILED DESCRIPTION OF EMBODIMENTS

In order to make the objective, technical solutions, and advantages of the embodiments of the present disclosure clearer, the following description will provide a clear and comprehensive explanation of the technical solutions in the embodiments of the present disclosure with reference to the drawings of the present disclosure. Clearly, the described embodiments are part of the embodiments of the present disclosure and not the entire embodiments. It should be noted that, without conflicts, various features in the embodiments of the present disclosure can be combined with each other, and the combined embodiments still fall within the protection scope of the present disclosure.

In the description of the present disclosure, the terms “first”, “second”, “third” and the like are only used for distinguishing descriptions, and cannot be understood as indicating or implying relative importance. The terms “vertical” and “parallel” do not indicate absolute verticality or parallelism but can refer to approximate verticality or approximate parallelism.

In the description of the present disclosure, it is further important to note that unless otherwise clearly stipulated and limited, the terms “provide”, “mount”, “interconnect”, and “connect” should be understood in a broad sense, for example, it can be a fixed connection, a detachable connection, or an integral connection; it can be a mechanical connection, or an electrical connection; and it can be a direct connection, an indirect connection through an intermediary, or an internal communication between two components. Those of ordinary skill in the art can understand the meanings of the above terms in the present disclosure according to specific situations.

It should be understood that, for ease of description and to simplify the explanation of the present disclosure, the terms “front” and “rear” refer to the front-rear direction y of the lighting apparatus along the light-emitting direction, the terms “left” and “right” refer to the left-right direction x of the lighting apparatus itself, and the terms “upper” and “lower” refer to the up-down direction z of the lighting apparatus itself, which generally correspond to the front-rear, left-right, and up-down directions of the vehicle. These terms are based on the orientations or positional relationships shown in the drawings and do not indicate or imply that the referred device or component must have a specific orientation or be constructed and operated in a particular orientation. Therefore, they should not be construed as limitations on the present disclosure. Furthermore, the orientation terms of the lighting apparatus in the present disclosure should be understood in conjunction with the actual mounting state.

In the present disclosure, the light-emitting pattern refers to the projection shape of the light from the vehicle lamp on the light distribution screen located 25 meters directly front of the vehicle. The cut-off line refers to the boundary where the light is projected onto the light distribution screen and the visual perception of the light changes significantly. The primary low-beam light pattern is the central region of the low-beam light pattern with high illuminance, and the auxiliary low-beam light pattern is the widened region of the low-beam light pattern, thus ensuring that the left and right illumination range of the low-beam light pattern meets the requirements.

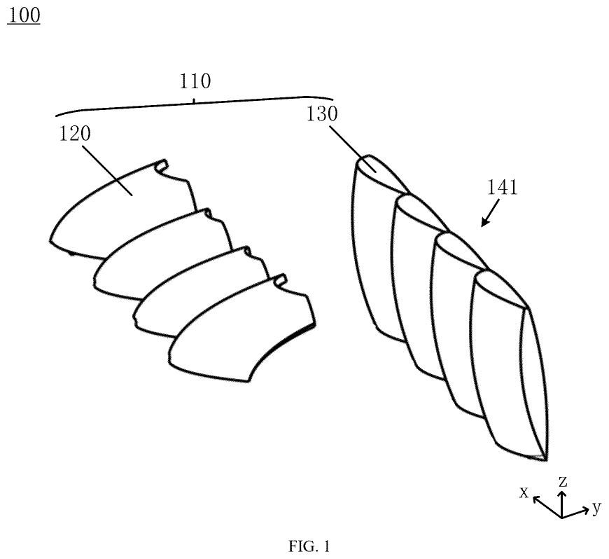

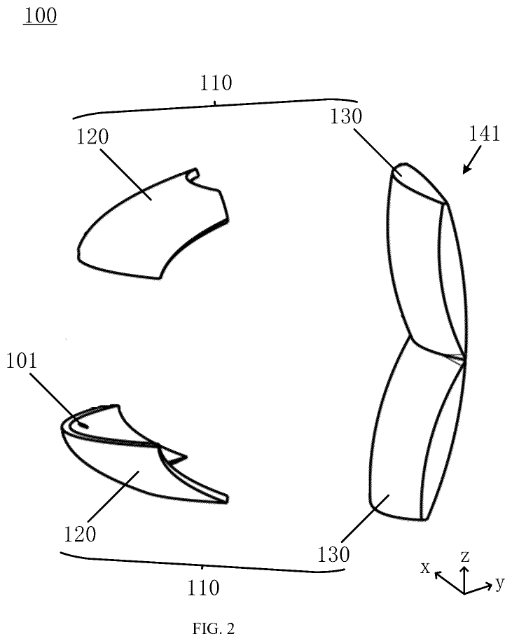

As one aspect of the embodiments of the present disclosure, as shown in FIG. 1 or FIG. 2, a light-emitting module 100 is provided, which includes multiple light sources 101 and multiple optical units 110. The light sources 101 are located on the light incident side of the optical units 110, thus facilitating the optical units 110 in modulating the light emitted from the light sources 101. As shown in FIG. 1, multiple optical units 110 are arranged in the transverse direction, and as shown in FIG. 2, multiple optical units 110 are arranged in the vertical direction.

As shown in FIG. 1 or FIG. 2, each optical unit 110 includes a reflection part 120 and a lens unit. The light source 101 corresponds to the reflection part 120, and the lens unit is located on the light-emitting side of the reflection part 120. The focuses of the lens units are arranged on the reflection surface of the reflection part 120 or near the reflection surface to ensure clear imaging. Accordingly, after the light source 101 emits light, the light is reflected by the reflection surface of the reflection part 120, enters the lens unit, and is modulated by the lens unit before finally being emitted to form a light pattern unit.

Thus, multiple optical units 110 of the light-emitting module 100 can form multiple light pattern units, and the combination of multiple light pattern units forms the light-emitting pattern of the light-emitting module 100.

Taking the light-emitting module 100 shown in FIG. 1 as an example, the light-emitting module 100 includes four optical units 110 arranged in the transverse direction (in the x direction). Each optical unit 110 is provided with a reflection part 120 and a lens unit. Each optical unit 110, in cooperation with the light source 101, can emit light to form a light pattern unit. Ultimately, the four light pattern units combine in the transverse direction to form the light-emitting pattern of the light-emitting module 100.

Taking the light-emitting module 100 shown in FIG. 2 as an example, the light-emitting module 100 includes two optical units 110 arranged in the vertical direction (in the z direction). Each optical unit 110 is provided with a reflection part 120 and a lens unit. Each optical unit 110, in cooperation with the light source 101, can emit light to form a light pattern unit. Ultimately, the two light pattern units combine to form the light-emitting pattern of the light-emitting module 100.

In summary, the light-emitting module 100 is modularized (with multiple light sources 101 and multiple optical units 110), making the optical units 110 within the light-emitting module 100 relatively independent, allowing for more flexible modulation of individual light patterns. Therefore, when the light-emitting pattern is locally adjusted, only part of the optical units 110 can be adjusted, and the remaining optical units 110 can be avoided from being adjusted. Compared to directly using a single large lens within the light-emitting module 100, the present disclosure helps shorten the development cycle, enables more refined adjustments of the light pattern, and improves the accuracy of achieving the desired light pattern.

It can be understood that in the light-emitting module 100 of the present disclosure, multiple light sources 101 and multiple optical units 110 can have a one-to-one correspondence or cannot, as long as each optical unit 110 can receive the light emitted by the light source 101 and modulate it accordingly to form a light pattern unit.

Additionally, the multiple optical units 110 arranged in the transverse direction or vertical direction can be approximately along the transverse direction or vertical direction, which does not refer to absolute transverse direction and absolute vertical direction. The specific arrangement can be adjusted according to the extension direction of the light-emitting surface of the lighting apparatus applying the light-emitting module 100 (e.g., flat surface, curved surface, etc.) and the light distribution requirements.

Further, when the focus of the lens unit is located on the reflection surface of the reflection part 120 or near the reflection surface, including but not limited to when the focus is located at the boundary of the reflection surface, near the boundary, or at a non-boundary location. For example, when the focal point is at the boundary of the reflection surface or near the boundary, the light-emitting module 100 can be applied in the low-beam lighting apparatus. When the focus is located on the reflection surface or near the reflection surface (excluding the boundary of the reflection surface or positions near the boundary), the light-emitting module 100 can be used in high-beam lighting apparatus.

Optionally, the lens unit includes a lens 130, which can firstly facilitate the miniaturization of the lens unit, and at the same time, can also avoid excessive light refraction to the outside, thereby reducing light loss. As shown in FIGS. 1 to 2, a cross-section of a light incident surface of the lens 130 (along an x direction) and a longitudinal section of a light-emitting surface of the lens 130 (along a z direction) are both curves. Therefore, after light is incident on the lens 130 via a reflection surface, the light incident surface and the light-emitting surface of the lens 130 can achieve bidirectional collimation, thereby obtaining a better light pattern effect in a light-emitting direction (along a y direction). Of course, in another embodiment, when the lens unit includes a lens 130, one of the cross-section and the longitudinal section of the light incident surface of the lens 130 is a curve, and the other is a straight line. Therefore, after light is incident on the lens 130 via the reflection surface, the light incident surface of the lens 130 can achieve unidirectional collimation, and a collimation direction can be transverse or longitudinal. It is also not precluded that, in another embodiment, the cross-section and the longitudinal section of the light incident surface of the lens are both curves.

Optionally, the lenses 130 of two adjacent lens units can be spliced to form a module lens 141. For example, as shown in FIG. 1, the lenses 130 that are arranged in the transverse direction are sequentially spliced in the transverse direction to form the module lens 141. For example, as shown in FIG. 2, the lenses 130 that are arranged in the vertical direction are sequentially spliced in the vertical direction to form the module lens 141.

Optionally, the lens unit can also include multiple lenses, thereby enabling light to be modulated multiple times, which facilitates obtaining a better light pattern. For example, as shown in FIG. 3, optical units 110 are arranged in the transverse direction (along the x direction), and the lens unit can also include an inner lens 150 and an outer lens 160, wherein the outer lens 160 is arranged on a light-emitting side of a reflection part 120, and the inner lens 150 is located between the reflection part 120 and the outer lens 160. Therefore, after the light is reflected by the reflection part 120, the light is first incident on the inner lens 150, and then the light is emitted from the inner lens 150 to the outer lens 160 and is finally emitted to form a light pattern unit. It should be understood that, in other embodiments, when the optical units 110 are arranged in a vertical direction (along the z direction), the lens unit can still include the inner lens 150 and the outer lens 160. The arrangement thereof differs from the embodiment in which the optical units are transversely arranged only in the arrangement direction. Therefore, the arrangement can be referred to and understood without further elaboration.

A front-rear position of the inner lens 150 in the lens unit along an optical axis direction (i.e., the y direction in FIG. 3) can be determined according to a focal length of the inner lens 150. Additionally, when the focal length of the inner lens 150 is increased, the brightness of the light pattern is improved, but a size of the light pattern is reduced. The focal length can be flexibly adjusted according to the light pattern and customer requirements.

When the lens unit achieves a collimation function, the light incident surface of the inner lens 150 can collimate light emitted from the reflection part 120 along a first direction, and the light-emitting surface of the outer lens 160 can collimate light emitted from the reflection part 120 along a second direction, wherein the first direction and the second direction are perpendicular to each other. Therefore, bidirectional collimation can be achieved through the combination of the inner lens 150 and the outer lens 160. In a specific implementation, as shown in FIG. 3, the first direction can be the x direction, the second direction can be the z direction, a cross-section of the light incident surface of the inner lens 150 along the x direction can be a curve, and a longitudinal section along the z direction can be a straight line; a longitudinal section of the light-emitting surface of the outer lens 160 along the z direction can be a curve, and a cross-section along the x direction can be a straight line.

Optionally, adjacent inner lenses 150 of multiple optical units 110 can be spliced to form a module inner lens 142, and adjacent outer lenses 160 of multiple optical units 110 can be spliced to form a module outer lens 143. For example, as shown in FIG. 3, four inner lenses 150 are sequentially spliced in the transverse direction to form the module inner lens 142, and four outer lenses 160 are spliced in the transverse direction to form the module outer lens 143.

Optionally, light-emitting surfaces of multiple lens units are connected to form a smooth light-emitting surface of a light-emitting module 100. For example, as shown in FIG. 2, when the lens unit includes a lens 130, the light-emitting surface of the module lens 141 formed along the vertical arrangement can be a smooth curved surface. Of course, in other embodiments, the light-emitting surface of the module lens 141 can also be a smooth planar surface. As shown in FIG. 3, the light-emitting surface of the module inner lens 142 can be a smooth planar surface, and the light incident surface of the module outer lens 143 and the light-emitting surface of the module outer lens 143 can be smooth curved surfaces.

It should be understood that, when the light incident surface and/or the light-emitting surface of the spliced module outer lens 143 is a smooth curved surface or a planar surface, and the module outer lens 143 is integrally molded, in an actual product, obvious boundary lines between units cannot be provided. For example, in FIG. 3, the light incident surface of the module outer lens 143 is a smooth curved surface, and in an actual product, obvious boundary lines between units cannot be provided. The dashed line, located at the light incident surface of the module outer lens 143 in FIG. 3, is a virtual line for facilitating the understanding of unit division, which cannot be provided in an actual product. Similarly, the light incident surface and the light-emitting surface of the module inner lens 142 are the same.

Optionally, as shown in FIGS. 1 to 3, a reflection surface of the reflection part 120 can be any one of a parabolic surface, a quasi-parabolic surface, an ellipsoidal surface, and a quasi-ellipsoidal surface, wherein the quasi-parabolic surface refers to a curved surface approximating a parabolic surface, and the quasi-ellipsoidal surface refers to a curved surface approximating an ellipsoidal surface. Regardless of which type of curved surface is used as the reflection surface, as long as the reflection surface enables light emitted from the light source 101 to be approximately parallelly emitted to the lens unit, it is helpful to improve light utilization efficiency and enhance illumination brightness.

The present disclosure provides the light-emitting module 100, which can be used in a lighting apparatus. The light-emitting module 100 can be used as any module among a high beam, a low beam, an auxiliary high beam, a corner lamp, and a fog lamp in the lighting apparatus. When the lighting apparatus includes multiple light-emitting modules 100, various illumination functions such as low beam and high beam, low beam and ADB high beam, main low beam and auxiliary low beam can be realized. According to different lighting functions, the lighting apparatus can be divided into a low beam lighting apparatus, a high beam lighting apparatus, a high and low beam integrated lighting apparatus, etc., and the present disclosure does not impose any specific restrictions on them.

By applying the aforementioned light-emitting module 100, the modular characteristics of the light-emitting module 100 can be utilized, which makes the light pattern modulation of each light-emitting module 100 in the lighting apparatus more flexible. This is beneficial for shortening the research and development cycle and achieving refined light pattern adjustments within the light-emitting module 100, thereby improving the accuracy of achieving the desired light pattern. On this basis, when the lighting apparatus includes multiple light-emitting modules 100, each light-emitting module 100 can remain independent. That is, during the design phase, the optical unit 110 within each light-emitting module 100 only needs to consider the light-emitting requirements of its own module. This allows each light-emitting module 100 to achieve more flexible light pattern modulation without interference, and avoids the design requirement for a single large lens that must simultaneously meet the light-emitting requirements of multiple light-emitting modules 100. Thus, when adjusting the light pattern of some modules among multiple light-emitting modules 100, it is only necessary to adjust the light-emitting module 100 that needs to be adjusted, which is beneficial for shortening the research and development cycle.

Further, since two adjacent light-emitting modules 100 are independent, there is no issue of shared usage, which can eliminate the need for arranging a structure to divide light pattern between them, such as a shading structure. This not only reduces costs but also allows for flexible adjustments to improve the continuity of the two light-emitting patterns corresponding to the adjacent light-emitting modules 100, thus avoiding dark regions being presented between two adjacent light-emitting patterns or excessive brightness at the junction.

For ease of description, the following will schematically describe the low-beam lighting apparatus, the high-beam lighting apparatus, and the high and low beam integrated lighting apparatus in conjunction with the drawings.

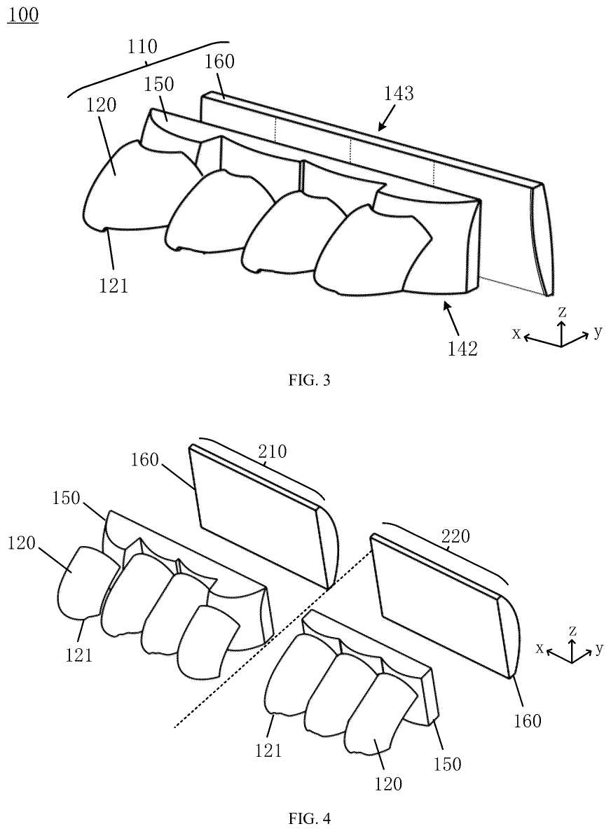

Another aspect of the present disclosure, as shown in FIG. 1, FIG. 3, or FIG. 4, provides a low-beam lighting apparatus, which includes at least one of the aforementioned light-emitting modules 100. The focus of the lens unit is arranged at a boundary of the reflection surface of the reflection part 120 close to the light source 101, or arranged near the boundary. This facilitates the use of the boundary or the vicinity of the boundary of the reflection surface as a cut-off line structure 121, thereby enabling the light-emitting module 100 to emit a low-beam light pattern with a light-dark cut-off line.

Optionally, as shown in FIG. 1, the low-beam lighting apparatus includes a light-emitting module 100, and the light-emitting module 100 is provided with multiple optical units 110 arranged in the transverse direction. Each optical unit 110 includes a reflection part 120 and a lens unit, wherein the lens unit includes a lens 130. Thus, the light reflected by the reflection part 120 passes through multiple lens units to form multiple light pattern units, and the multiple light pattern units, when combined, can form a low-beam light pattern.

Optionally, as shown in FIG. 3, the low-beam lighting apparatus includes a light-emitting module 100, and the light-emitting module 100 is provided with multiple optical units 110 arranged in the transverse direction. Each optical unit 110 includes a reflection part 120 and a lens unit, wherein the lens unit includes an inner lens 150 and an outer lens 160. Thus, the light reflected by the reflection part 120 passes through multiple lens units to form multiple light pattern units, and the multiple light pattern units, when combined, can form a low-beam light pattern.

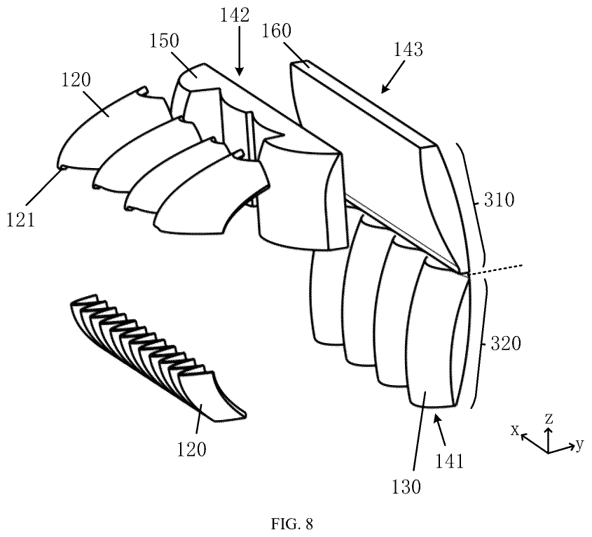

Optionally, as shown in FIG. 1 to FIG. 4, the reflection part 120 corresponds one-to-one with the lens unit. Of course, in other implementations, multiple reflection parts 120 can correspond to one lens unit. For example, this can be arranged with reference to the high-beam light-emitting module 320 in FIG. 8, where multiple reflection parts 120 correspond to a single lens unit.

Optionally, the low-beam lighting apparatus can also include multiple light-emitting modules 100. In this manner, the low-beam light pattern of the low-beam lighting apparatus can be obtained by superimposing the light-emitting patterns formed by multiple light-emitting modules 100.

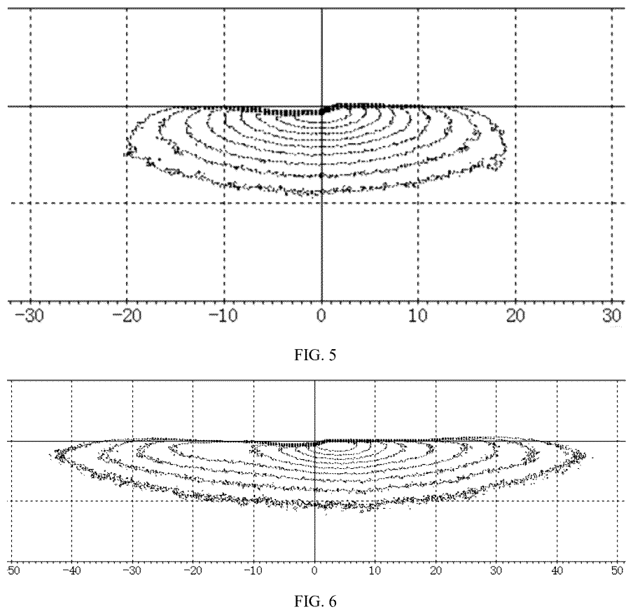

For example, as shown in FIG. 4, the low-beam lighting apparatus includes two light-emitting modules 100, namely a primary low-beam module 220 and an auxiliary low-beam module 210. For ease of understanding, the low-beam lighting apparatus is divided into the primary low-beam module 220 and the auxiliary low-beam module 210 with dashed lines. The primary low-beam module 220 can emit light correspondingly to form a primary low-beam light pattern, and the auxiliary low-beam module 210 is configured to emit light correspondingly to form an auxiliary low-beam light pattern. Specifically, in FIG. 4, the primary low-beam module 220 includes multiple light sources 101 and multiple optical units 110. The multiple optical units 110 include a reflection part 120 and a lens unit. The lens unit includes an inner lens 150 collimated along the x direction and an outer lens 160 collimated along the z direction. The multiple inner lenses 150 are spliced to form a module inner lens 142, and the multiple outer lenses 160 are spliced to form a module outer lens 143. Thus, as shown in FIG. 5, for the primary low-beam module 220, the light sources 101 are emitted along the y direction through multiple optical units 110 to form multiple light pattern units. The multiple light pattern units are combined to form a primary low-beam light pattern having a light-dark cut-off line.

In FIG. 4, the auxiliary low-beam module 210 includes multiple light sources 101 and multiple optical units 110. The multiple optical units 110 include a reflection part 120 and a lens unit. The lens unit includes an inner lens 150 collimated along the x direction and an outer lens 160 collimated along the z direction. The multiple inner lenses 150 are spliced to form a module inner lens 142, and the multiple outer lenses 160 are spliced to form a module outer lens 143. Thus, as shown in FIG. 6, for the auxiliary low-beam module 210, the light sources 101 are emitted along the y direction through multiple optical units 110 to form multiple light pattern units. The multiple light pattern units are combined to form an auxiliary low-beam light pattern having a light-dark cut-off line.

By superimposing the primary low-beam light pattern shown in FIG. 5 and the auxiliary low-beam light pattern shown in FIG. 6, a low-beam light pattern of a low-beam lighting apparatus can be obtained. The primary low-beam light pattern can improve the central brightness of the low-beam light pattern, and the auxiliary low-beam light pattern can enable the low-beam light pattern to be widened more effectively.

Of course, multiple light-emitting modules 100 can be arranged in a transverse direction or a vertical direction. The present disclosure does not impose special limitations thereon and allows reasonable arrangement according to requirements.

Optionally, the multiple optical units 110 are arranged in a transverse direction, and an arrangement direction of the light-emitting module 100 is parallel to an arrangement direction of the optical units 110. For example, as shown in FIG. 4, the optical units 110 in the primary low-beam module 220 and the auxiliary low-beam module 210 are arranged in a transverse direction (along the x direction), and the primary low-beam module 220 and the auxiliary low-beam module 210 are also arranged in a transverse direction (along the x direction).

Optionally, the multiple optical units 110 are arranged in a transverse direction, and an arrangement direction of the light-emitting module 100 is perpendicular to the arrangement direction of the optical units 110. For example, the optical units 110 in the primary low-beam module 220 and the auxiliary low-beam module 210 are arranged in a transverse direction, and the primary low-beam module 220 and the auxiliary low-beam module 210 can also arranged in a vertical direction.

Optionally, two adjacent light-emitting modules 100 among the multiple light-emitting modules 100 cannot be spliced, that is, have a spacing. For example, as shown in FIG. 4, a gap is provided between the primary low-beam module 220 and the auxiliary low-beam module 210.

Optionally, the light-emitting surfaces of two adjacent light-emitting modules 100 among the multiple light-emitting modules 100 are connected to form a smooth curved surface or a planar surface. For example, no gap is provided between the primary low-beam module 220 and the auxiliary low-beam module 210 in FIG. 4, so that the light-emitting surfaces of the module outer lens 143 or module lens 141 in the primary low-beam module 220 and the auxiliary low-beam module 210 are connected to form a smooth curved surface or a planar surface.

In another aspect of the embodiments of the present disclosure, a high-beam lighting apparatus is provided, including at least one of the above-described light-emitting modules 100. A focus of the lens unit can be arranged on or near the reflection surface (except the boundary of the reflection surface or positions near the boundary). Thus, obstruction to a formed high-beam light pattern is avoided.

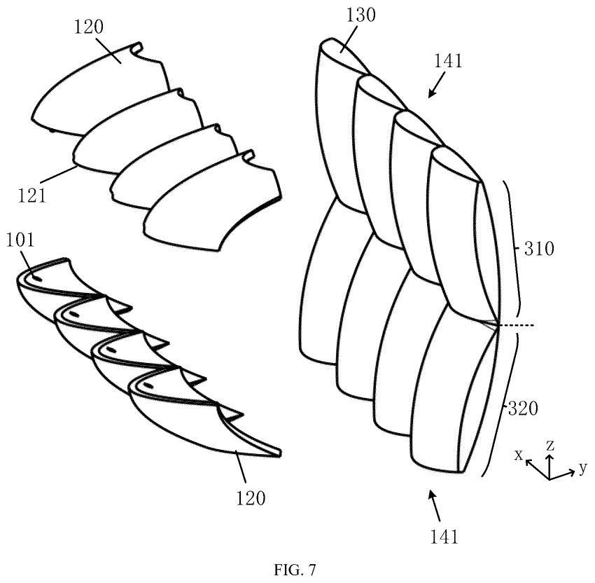

The high-beam lighting apparatus provides a light-emitting module 100. For example, in FIG. 7, the light-emitting module 100 is located below a dashed line and serves as a high-beam light-emitting module 320. The high-beam module is provided with multiple optical units 110 arranged in the transverse direction. Each optical unit 110 includes a reflection part 120 and a lens unit, wherein the lens unit includes a lens 130. Thus, the light reflected by the reflection part 120 passes through the lens unit to form multiple light pattern units, and the multiple light pattern units, when combined, can form a high-beam light pattern.

The high-beam lighting apparatus provides a light-emitting module 100. For example, in FIG. 9, the light-emitting module 100 is located below a dashed line and serves as a high-beam light-emitting module 320. The high-beam module is provided with multiple optical units 110 arranged in the transverse direction. Each optical unit 110 includes a reflection part 120 and a lens unit, wherein the lens unit includes a high-beam inner lens 191 and a high-beam outer lens 192. Thus, the light reflected by the reflection part 120 passes through the lens unit to form multiple light pattern units, and the multiple light pattern units, when combined, can form a high-beam light pattern.

Of course, in other embodiments, the high-beam lighting apparatus can also provide two or more light-emitting modules 100. When two or more light-emitting modules 100 are arranged, they can also be arranged in a transverse direction or a vertical direction.

Optionally, as shown in FIG. 7 or FIG. 9, the reflection surface of the high-beam module corresponds one-to-one with the lens unit. Of course, in other embodiments, for example, in FIG. 8, multiple reflection surfaces in the high-beam light-emitting module 320 correspond to one lens unit, which is configured for ADB high-beam lighting.

Optionally, in the high-beam lighting apparatus, two adjacent light-emitting modules 100 among the multiple light-emitting modules 100 cannot be spliced, that is, have a spacing.

Optionally, in the high-beam lighting apparatus, the light-emitting surfaces of two adjacent light-emitting modules 100 among the multiple light-emitting modules 100 are connected to form a smooth curved surface or a planar surface.

Another aspect of the present disclosure provides a high and low beam integrated lighting apparatus. As shown in FIGS. 7 to 11, the high and low beam integrated lighting apparatus includes two above-mentioned light-emitting modules 100. One light-emitting module 100 is a low-beam light-emitting module 310 capable of forming a low-beam light pattern, and the other light-emitting module 100 is a high-beam light-emitting module 320 capable of forming a high-beam light pattern.

For example, as shown in FIGS. 7 to 11, the high and low beam integrated lighting apparatus is divided into the low-beam light-emitting module 310 and the high-beam light-emitting module 320 with a dashed line as the boundary.

Optionally, the lens unit of one of the low-beam light-emitting module 310 and the high-beam light-emitting module 320 includes a lens 130. For example, as shown in FIG. 7, the low-beam light-emitting module 310 includes multiple light sources 101 and multiple optical units 110. The multiple optical units 110 include a reflection part 120 and a lens unit. The lens unit includes a bidirectionally collimated lens 130, and multiple lenses 130 are spliced to form a module lens 141. Thus, for the low-beam light-emitting module 310, the light sources 101 are emitted along the y direction through multiple optical units 110 to form multiple light pattern units. The multiple light pattern units are combined to form a low-beam light pattern having a light-dark cut-off line. Referring further to FIG. 7, the high-beam light-emitting module 320 includes multiple light sources 101 and multiple optical units 110. The multiple optical units 110 include a reflection part 120 and a lens unit. The lens unit includes a bidirectionally collimated lens 130, and multiple lenses 130 are spliced to form a module lens 141. Thus, for the high-beam light-emitting module 320, the light sources 101 are emitted along the y direction through multiple optical units 110 to form multiple light pattern units. The multiple light pattern units are combined to form a high-beam light pattern.

Optionally, the lens unit of one of the low-beam light-emitting module 310 and the high-beam light-emitting module 320 includes a lens 130, and the lens unit of the other includes an inner lens 150 and an outer lens 160 sequentially arranged on the light-emitting side of the reflection part 120. For example, as shown in FIG. 8, the low-beam light-emitting module 310 includes multiple light sources 101 and multiple optical units 110. The multiple optical units 110 include a reflection part 120 and a lens unit. The lens unit includes an inner lens 150 collimated along the x direction and an outer lens 160 collimated along the z direction. The multiple inner lenses 150 are spliced to form a module inner lens 142, and the multiple outer lenses 160 are spliced to form a module outer lens 143. Thus, for the low-beam light-emitting module 310, the light sources 101 are emitted along the y direction through multiple optical units 110 to form multiple light pattern units. The multiple light pattern units are combined to form a low-beam light pattern having a light-dark cut-off line. Referring further to FIG. 8, the high-beam light-emitting module 320 includes multiple light sources 101 and multiple optical units 110. The multiple optical units 110 include a reflection part 120 and a lens unit. The lens unit includes a lens 130 that is bidirectionally collimated in both the x-direction and the z-direction, and multiple lenses 130 are spliced to form a module lens 141. Thus, for the high-beam light-emitting module 320, the light sources 101 are emitted along the y direction through multiple optical units 110 to form multiple light pattern units. The multiple light pattern units are combined to form a high-beam light pattern.

Optionally, as shown in FIG. 9, the lens unit of the low-beam light-emitting module 310 includes a low-beam inner lens 181 and a low-beam outer lens 182 sequentially arranged on the light-emitting side of the reflection part 120; the lens unit of the high-beam light-emitting module 320 includes a high-beam inner lens 191 and a high-beam outer lens 192 sequentially arranged on the light-emitting side of the reflection part 120. Adjacent low-beam inner lenses 181 are spliced to form a low-beam inner lenses 181, and adjacent low-beam outer lenses 182 are spliced to form a low-beam module outer lens 143. Adjacent high-beam inner lenses 191 are spliced to form a high-beam inner lenses 191, and adjacent high-beam outer lenses 192 are spliced to form a high-beam module outer lens 143.

Optionally, as shown in FIGS. 7 to 11, the low-beam light-emitting module 310 and the high-beam light-emitting module 320 are arranged in a vertical direction (i.e., z-direction).

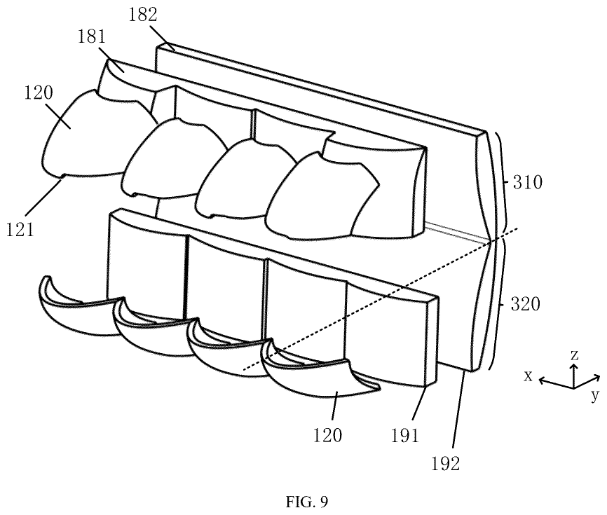

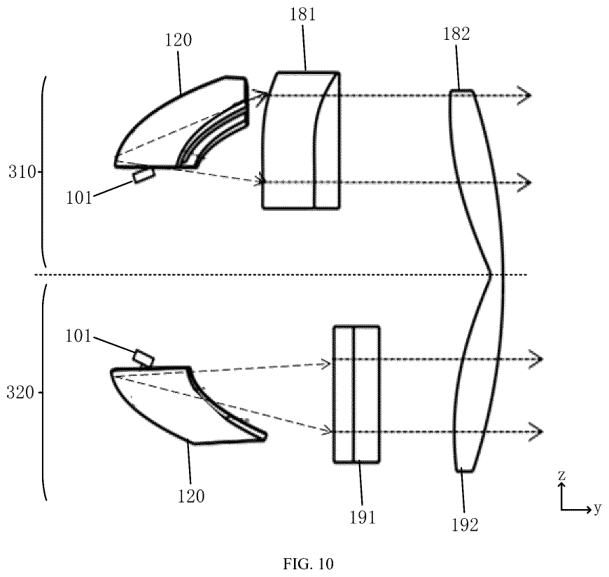

Optionally, the low-beam inner lens 181 and the high-beam inner lens 191 are arranged front-to-rear along the front-rear direction (along the y-direction). For example, as shown in FIG. 10, the low-beam inner lens 181 is arranged at the rear, and the high-beam inner lens 191 is arranged at the front. The arrangement can be determined based on the focal lengths of each. It should be understood that as the focal length increases, brightness increases, but the size of the light pattern decreases. Therefore, the focal length can be set reasonably according to the light pattern and customer requirements. Of course, in another embodiment, the low-beam inner lens 181 and the high-beam inner lens 191 are arranged along the vertical direction (along the z-direction) and integrally molded, that is, the low-beam inner lens 181 and the high-beam inner lens 191 are spliced along the vertical direction.

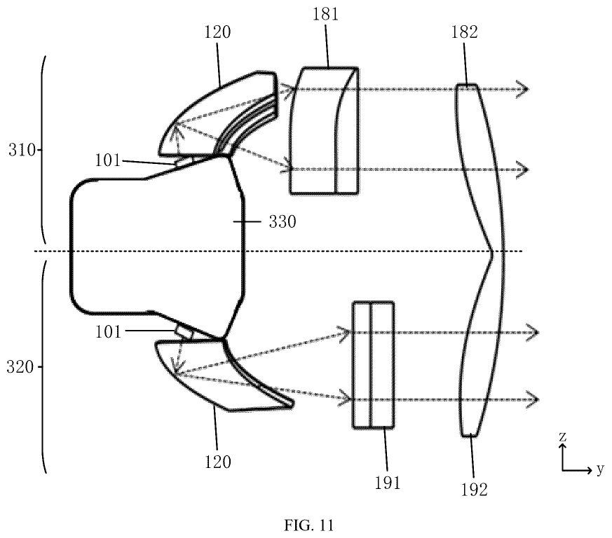

In another optional embodiment, to dissipate heat from the light sources 101, a heat sink 330 can be arranged between the light sources 101 of two adjacent light-emitting modules 100. By utilizing the opposite sides of the heat sink 330, the light sources 101 of the two light-emitting modules 100 can be separately cooled. This can fully utilize the space between the light sources 101 of the two light-emitting modules 100, thereby reducing the volume. For example, as shown in FIG. 11, a heat sink 330 can be arranged between the light sources 101 of the low-beam light-emitting module 310 and the high-beam light-emitting module 320. By utilizing the opposite sides of the heat sink 330, the light sources 101 of the two light-emitting modules 100 can be separately cooled.

Optionally, to enhance the heat dissipation capability of the light sources 101, a corresponding heat sink 330 can be provided for the light source 101 of each light-emitting module 100. For example, as shown in FIG. 21, a heat sink 330 can be arranged on the side of the low-beam light-emitting module 310 that is away from the high-beam light-emitting module 320 to dissipate heat from the light source 101 of the low-beam light-emitting module 310. Similarly, a heat sink 330 can be arranged on the side of the high-beam light-emitting module 320 that is away from the low-beam light-emitting module 310 to dissipate heat from the light source 101 of the high-beam light-emitting module 320.

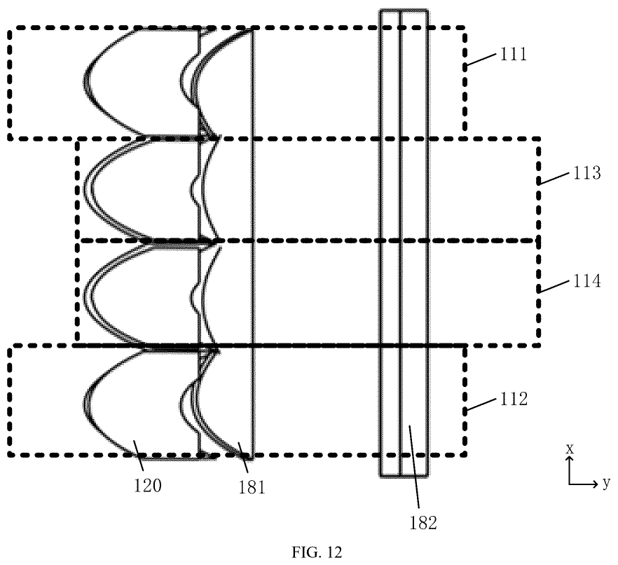

Optionally, as shown in FIG. 12, the low-beam light-emitting module 310 includes four light sources 101 and four optical units 110. The four optical units 110 are schematically represented by the four dashed-line boxes shown in FIG. 12 and are sequentially arranged along the x-direction as a first unit 111, a second unit 112, a third unit 113, and a fourth unit 114. The light-emitting direction is the y-direction. The first unit 111 and the second unit 112 are two units close to the edge, respectively, and the third unit 113 and the fourth unit 114 are two units close to the middle, respectively.

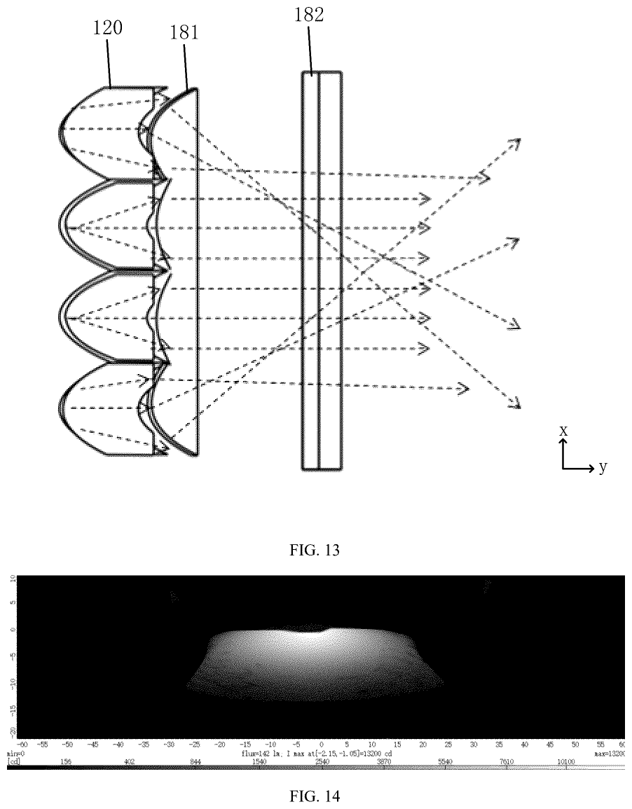

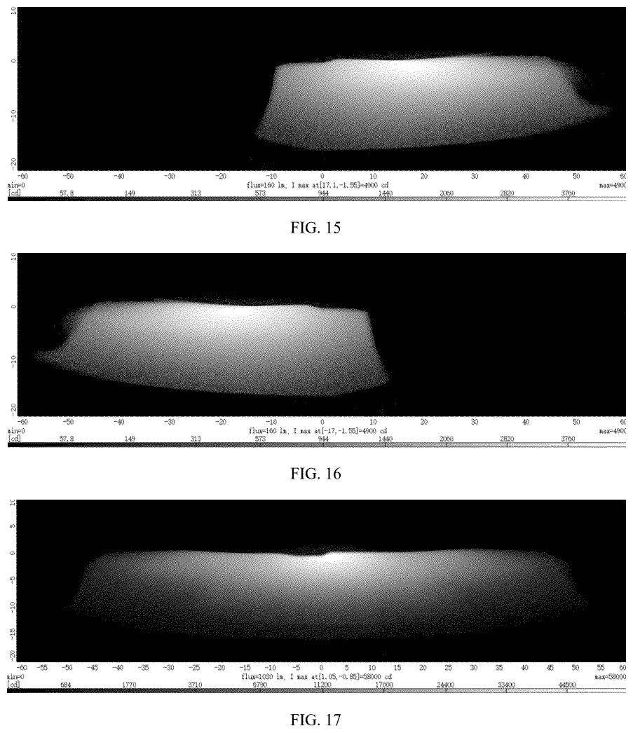

To obtain a better low-beam light pattern, the inner lenses 150 of different optical units 110 in the low-beam light-emitting module 310 can be arranged differently. For example, in FIG. 12, the curvature of the cross-section of the light incident surface of the inner lenses 150 of the first unit 111 and the second unit 112, which are near the edges, is greater than the curvature of the cross-section of the light incident surface of the inner lenses 150 of the third unit 113 and the fourth unit 114, which are near the center. Accordingly, as shown in FIG. 13, when light reflected by the reflection surface enters the low-beam inner lens 181, a portion of the light entering the first unit 111 and the second unit 112 undergoes a larger refraction angle, thereby expanding the illumination region. This obtains a right-half light pattern corresponding to the first unit 111, as shown in FIG. 15, and a left-half light pattern corresponding to the second unit 112, as shown in FIG. 16. The light entering the third unit 113 and the fourth unit 114 forms a central light pattern, as shown in FIG. 14. The three forms superimpose to produce a low-beam light pattern with better widening, as shown in FIG. 17. At the same time, as shown in FIG. 13, the light incident through the light incident surfaces with larger cross-sectional curvatures on both sides of the low-beam inner lens 181 (the inner lenses 150 of the first unit 111 and the second unit 112) will cross each other in the transverse direction (x direction), i.e., the horizontal direction, due to the large-angle refraction. When the module outer lens 143 is arranged at a point in the optical path during the crossing process, it is possible to allow the light to pass through without requiring a wide module outer lens 143. Thus, the left and right openings of the lens can be further reduced.

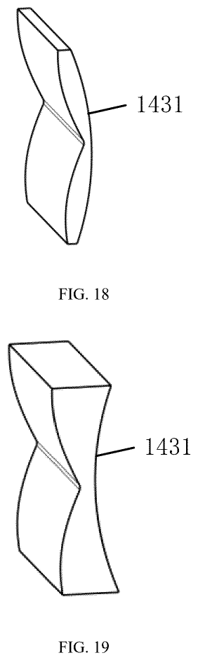

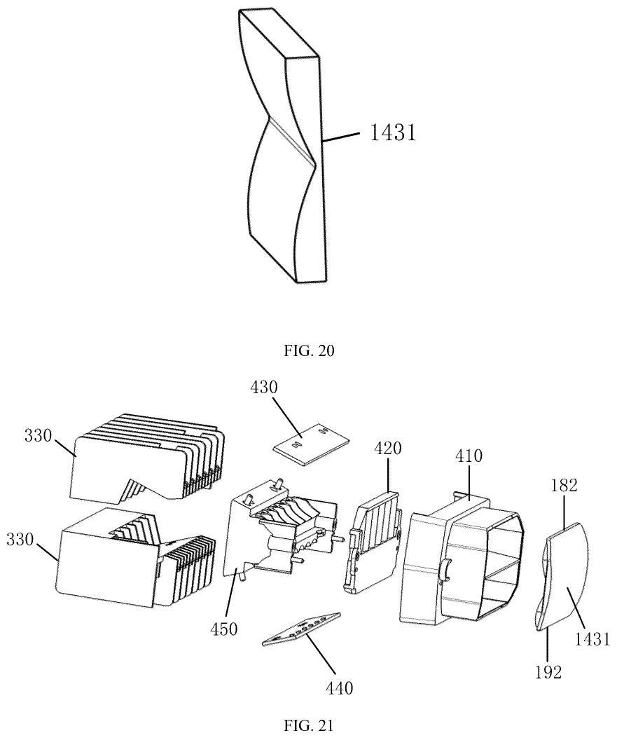

As shown in FIG. 18 or FIG. 19, the surface shape 1431 formed by connecting the light-emitting surfaces of outer lenses of adjacent light-emitting modules can be a curved surface that is convex or concave, thereby improving the continuity of appearance. Of course, as needed, the surface shape 1431 formed by connecting the light-emitting surfaces of the outer lenses of adjacent light-emitting modules can also be changed accordingly. For example, as shown in FIG. 20, the surface shape 1431 formed by connecting the light-emitting surfaces of the outer lenses of adjacent light-emitting modules can be a flat surface.

Optionally, as shown in FIG. 21, the high and low beam integrated lighting apparatus includes a reflecting assembly 450 that fixes the reflection part 120, a low-beam circuit board 440 that integrates the light source 101 of the low-beam light-emitting module 310, a high-beam circuit board 430 that integrates the light source 101 of the high-beam light-emitting module 320, an inner lens assembly 420 provided with the low-beam inner lens 181 and the high-beam inner lens 191, a lens bracket 410, and an integral connection of the low-beam outer lens 182 and the high-beam outer lens 192, which are assembled along the direction of the light path.

Another aspect of the present disclosure provides a vehicle lamp, which includes the above-described low-beam lighting apparatus, the above-described high-beam lighting apparatus, or the above-described high and low beam integrated lighting apparatus. The vehicle lamp of the present disclosure can be applied to transportation vehicles such as bicycles, motorcycles, automobiles, ships, and aircraft, without limitation in the present disclosure.

The above is only a preferred embodiment of the present disclosure, which is not intended to limit, and the present disclosure may have various changes and variations for those skilled in the art. Any modification, equivalent substitution, improvement, etc. made within the spirit and principles of the present disclosure shall be included in the scope of protection of the present disclosure.

### INDUSTRIAL PRACTICALITY

The present disclosure provides a high and low beam integrated lighting apparatus and a vehicle lamp, in which the low-beam light-emitting module and the high-beam light-emitting module are provided with optical units to achieve modularization. Therefore, this makes each light-emitting module relatively independent, and their light pattern modulation is more flexible without interfering with each other, which can shorten the research and development cycle. The vehicle lamp of the present disclosure can be applied to transportation vehicles such as bicycles, motorcycles, automobiles, ships, and aircraft.

1. A high and low beam integrated lighting apparatus, comprising two light-emitting modules which are arranged in a vertical direction, wherein each light-emitting module comprises multiple light sources and multiple optical units, and the multiple optical units are arranged in a transverse direction; the optical unit comprises a reflection part and a lens unit located on a light-emitting side of the reflection part, wherein the light sources are arranged corresponding to the reflection parts; the reflection part is provided with a reflection surface, focuses of the lens units are provided on the reflection surfaces or near the reflection surfaces, light emitted by the light sources is reflected by the reflection surfaces and then are emitted through the lens units, to form light pattern units, and the multiple light pattern units are combined to form light-emitting patterns of the light-emitting modules;
one of the two light-emitting modules is a low-beam light-emitting module capable of forming a low-beam light pattern, and another is a high-beam light-emitting module capable of forming a high-beam light pattern; and light-emitting surfaces of the two light-emitting modules are connected to form a smooth curved face.

2. The high and low beam integrated lighting apparatus according to claim 1, wherein the lens unit comprises one lens, and both a cross-section and a longitudinal section of a light incident surface of the lens are curved lines; or one of the cross-section and the longitudinal section of the light incident surface of the lens is a curved line, and another is a straight line.

3. The high and low beam integrated lighting apparatus according to claim 1, wherein the lens unit comprises an inner lens and an outer lens sequentially arranged on the light-emitting side of the reflection part, adjacent inner lenses are spliced to form a module inner lens, and adjacent outer lenses are spliced to form a module outer lens.

4. The high and low beam integrated lighting apparatus according to claim 3, wherein a light incident surface of the inner lens is configured to collimate light emitted from the reflection part along a first direction, a light-emitting surface of the outer lens is configured to collimate the light emitted from the reflection part along a second direction, and the first direction and the second direction are perpendicular.

5. The high and low beam integrated lighting apparatus according to claim 3, wherein a curvature of a cross-section of a light incident surface of the inner lens located at a side portion of the module inner lens is greater than a curvature of a cross-section of a light incident surface of the inner lens located at a middle portion of the module inner lens.

6. The high and low beam integrated lighting apparatus according to claim 1, wherein the reflection surface is any one of a parabolic surface, a quasi-parabolic surface, an ellipsoidal surface, and a quasi-ellipsoidal surface, and the reflection surface is capable of reflecting light emitted from the light sources substantially parallel to the lens unit.

7. The high and low beam integrated lighting apparatus according to claim 1, wherein the lens unit of one of the low-beam light-emitting module and the high-beam light-emitting module comprises one lens, and the lens unit of another comprises an inner lens and an outer lens sequentially arranged on a light-emitting side of the reflection part.

8. The high and low beam integrated lighting apparatus according to claim 1, wherein the lens unit of the low-beam light-emitting module comprises a low-beam inner lens and a low-beam outer lens sequentially arranged on a light-emitting side of the reflection part; the lens unit of the high-beam light-emitting module comprises a high-beam inner lens and a high-beam outer lens sequentially arranged on the light-emitting side of the reflection part; adjacent low-beam inner lenses are spliced to form a low-beam module inner lens, and adjacent low-beam outer lenses are spliced to form a low-beam module outer lens; and adjacent high-beam inner lenses are spliced to form a high-beam module inner lens, and adjacent high-beam outer lenses are spliced to form a high-beam module outer lens.

9. The high and low beam integrated lighting apparatus according to claim 8, wherein the low-beam module inner lens and the high-beam module inner lens are arranged in a front-rear direction; or the low-beam module inner lens and the high-beam module inner lens are arranged in a vertical direction and integrally molded.

10. A vehicle lamp, comprising the high and low beam integrated lighting apparatus according to claim 1.

11. The vehicle lamp according to claim 10, wherein the lens unit comprises one lens, and both a cross-section and a longitudinal section of a light incident surface of the lens are curved lines; or one of the cross-section and the longitudinal section of the light incident surface of the lens is a curved line, and another is a straight line.

12. The vehicle lamp according to claim 10, wherein the lens unit comprises an inner lens and an outer lens sequentially arranged on the light-emitting side of the reflection part, adjacent inner lenses are spliced to form a module inner lens, and adjacent outer lenses are spliced to form a module outer lens.

13. The vehicle lamp according to claim 12, wherein a light incident surface of the inner lens is configured to collimate light emitted from the reflection part along a first direction, a light-emitting surface of the outer lens is configured to collimate the light emitted from the reflection part along a second direction, and the first direction and the second direction are perpendicular.

14. The vehicle lamp according to claim 12, wherein a curvature of a cross-section of a light incident surface of the inner lens located at a side portion of the module inner lens is greater than a curvature of a cross-section of a light incident surface of the inner lens located at a middle portion of the module inner lens.

15. The vehicle lamp according to claim 10, wherein the reflection surface is any one of a parabolic surface, a quasi-parabolic surface, an ellipsoidal surface, and a quasi-ellipsoidal surface, and the reflection surface is capable of reflecting light emitted from the light sources substantially parallel to the lens unit.

16. The vehicle lamp according to claim 10, wherein the lens unit of one of the low-beam light-emitting module and the high-beam light-emitting module comprises one lens, and the lens unit of another comprises an inner lens and an outer lens sequentially arranged on a light-emitting side of the reflection part.

17. The vehicle lamp according to claim 10, wherein the lens unit of the low-beam light-emitting module comprises a low-beam inner lens and a low-beam outer lens sequentially arranged on a light-emitting side of the reflection part; the lens unit of the high-beam light-emitting module comprises a high-beam inner lens and a high-beam outer lens sequentially arranged on the light-emitting side of the reflection part; adjacent low-beam inner lenses are spliced to form a low-beam module inner lens, and adjacent low-beam outer lenses are spliced to form a low-beam module outer lens; and adjacent high-beam inner lenses are spliced to form a high-beam module inner lens, and adjacent high-beam outer lenses are spliced to form a high-beam module outer lens.

18. The vehicle lamp according to claim 17, wherein the low-beam module inner lens and the high-beam module inner lens are arranged in a front-rear direction; or the low-beam module inner lens and the high-beam module inner lens are arranged in a vertical direction and integrally molded.

19. The high and low beam integrated lighting apparatus according to claim 2, wherein the lens unit of one of the low-beam light-emitting module and the high-beam light-emitting module comprises one lens, and the lens unit of another comprises an inner lens and an outer lens sequentially arranged on a light-emitting side of the reflection part.

20. The high and low beam integrated lighting apparatus according to claim 2, wherein the lens unit of the low-beam light-emitting module comprises a low-beam inner lens and a low-beam outer lens sequentially arranged on a light-emitting side of the reflection part; the lens unit of the high-beam light-emitting module comprises a high-beam inner lens and a high-beam outer lens sequentially arranged on the light-emitting side of the reflection part; adjacent low-beam inner lenses are spliced to form a low-beam module inner lens, and adjacent low-beam outer lenses are spliced to form a low-beam module outer lens; and adjacent high-beam inner lenses are spliced to form a high-beam module inner lens, and adjacent high-beam outer lenses are spliced to form a high-beam module outer lens.
